(19) United States
(12) Patent Application Publication
(10) Pub. No.: US 2008/0296463 A1
(43) Pub. Date: Dec. 4, 2008

(54) Adjustable rotation base

(76) Inventor: Wanda Ying Li, Santa Ana, CA (US)

Correspondence Address: DAVID AND RAYMOND PATENT FIRM, 108 N. YNEZ AVE., SUITE 128, MONTEREY PARK, CA, 91754, US

(21) Appl. No.: 11/807,661

(22) Filed: May 29, 2007

(51) Int. Cl. F16M 13/02

(52) U.S. Cl. 248/519

(57) ABSTRACT

An adjustable rotation base includes a base housing and a transportation arrangement. The base housing has a bottom side, an upper side for coupling with the supporting post to support the outer umbrella in an upright manner, and a receiving cavity indently formed on the bottom side of the base housing, wherein the base housing includes a stationary unit provided at the bottom side for sitting on the ground surface in a stationary manner, and a plurality of transferring wheels rotatably supported at the bottom side of the base housing. The transportation arrangement is provided at the base housing to operate the base housing between an idle mode and a transportation mode in which the stationary unit is upwardly lifted to allow the transferring wheels being sitting on the ground surface, such that the base housing is adapted to be transported on the ground surface via the transferring wheels.

### BACKGROUND OF THE PRESENT INVENTION

1. Field of Invention

The present invention relates to an outdoor umbrella, and more particularly to an adjustable rotation base for an outdoor umbrella, wherein the adjustable rotation base comprises a transportation arrangement adapted to selectively and conveniently transport the outdoor umbrella for a predetermined distance.

2. Description of Related Arts

A conventional outdoor umbrella usually comprises a supporting base, a central stem upwardly extended from the supporting base, and an awning extended from a top portion of the central stem to provide shading for a predetermined shading area under an awning attached onto the awning frame. This kind of conventional outdoor umbrella has widely been utilized all around the nation for shading sunlight and providing a place where a wide variety of outdoor activities may take place. In order to enhance the performance and function of a typical outdoor umbrella, many inventions have been made to incorporate with a typical outdoor umbrella for achieving additional utility functions of that outdoor umbrella. For example, solar energy systems and illumination systems have been developed provide an environmentally-friendly energy source and illumination to outdoor umbrellas.

Despite these developments, there exists one deep-seated problem which has not been adequately resolved by one skilled in the art. The problem is that the outdoor umbrella is difficult or inconvenient to move while being used in outdoor environment. The most typical instance is that when a user wishes to move the outdoor umbrella from one place to another in a campsite, he or she has to lift up the entire outdoor umbrella and carry it to the intended destination. If that user is unable to move the outdoor umbrella due to its heavy weight, he or she has to ask for help from other people. This scenario presents undue inconvenience and sometimes embarrassment to that user because he or she may actually have to ask the guests to help him or her to move the outdoor umbrella. This scenario is worsened by the fact that in order to stabilize the outdoor umbrella as a whole when it is standing on a ground surface, the supporting base is often disposed with water or sand (i.e. objects of high density) for preventing accidental toppling of the outdoor umbrella. Thus, a typical outdoor umbrella is likely to be very heavy in weight.

In order to inject mobility to a typical outdoor umbrella, one may think that installing some sorts of wheels would be helpful. The problem, however, is that when the user wishes the outdoor umbrella to be stationary for prolonged used, the wheels may actually cause accidental yet undesirable movement of the outdoor umbrella. Therefore, there exist circumstances in which the user of outdoor umbrella may not wish it to be movable. Simply installing wheels to the outdoor umbrella does not resolve this extra problem.

### SUMMARY OF THE PRESENT INVENTION

A main object of the present invention is to provide an adjustable rotation base for an outdoor umbrella, wherein the adjustable rotation base comprises a transportation arrangement adapted to selectively and conveniently transport the outdoor umbrella for a predetermined distance despite its heavy weight.

Another object of the present invention is to provide an adjustable rotation base for an outdoor umbrella, wherein the adjustable rotation base is adapted to selectively operate between an idle mode which allows the outdoor umbrella to securely stand on a ground surface, and a transporting mode which allow convenient and easy transportation of the outdoor umbrella. In other words, the present invention allows selective adjustment of the position of the outdoor umbrella.

Another object of the present invention is to provide an adjustable rotation base which can be utilized for a wide variety of outdoor umbrellas in a wide variety of circumstances so as to ensure widespread application of the present invention. More importantly, the present invention does not interfere with the operation of the outdoor umbrella.

Another object of the present invention is to provide an adjustable rotation base for an outdoor umbrella, which does not involve expensive or complicated mechanical or electrical components so as to minimize the manufacturing cost and the ultimate selling price of the present invention.

Accordingly, in order to accomplish the above objects, the present invention provides an adjustable rotation base for supporting an outdoor umbrella having a supporting post on a ground surface, wherein the adjustable rotation base comprises:

a base housing having a bottom side, an upper side for coupling with the supporting post to support the outer umbrella in an upright manner, and a receiving cavity indently formed on the bottom side of the base housing, wherein the base housing comprises a stationary unit provided at the bottom side for stationary sitting on the ground surface and a plurality of transferring wheels rotatably supported at the bottom side of the base housing; and

an transportation arrangement provided at the base housing to operate the base housing between an idle mode and a transportation mode, wherein in the idle mode, the transferring wheels are suspenedly lifted up to define a clearance between the transferring wheels and the ground surface such the base housing is stationary sat on the ground surface via the stationary unit, and in the transportation mode, the stationary unit is upwardly lifted to allow the transferring wheels being sitting on the ground surface, such that the base housing is adapted to be transported on the ground surface via the transferring wheels.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of an adjustable rotation base according to a preferred embodiment of the present invention.

FIG. 2 is an exploded perspective view of the adjustable rotation base according to the above preferred embodiment of the present invention.

FIG. 3A and FIG. 3B are sectional side views of the adjustable rotation base according to the above preferred embodiment of the present invention.

FIG. 4 is a schematic diagram of a driving unit according to the above preferred embodiment of the present invention.

FIG. 5A and FIG. 5B are other schematic diagrams of the driving unit according to the above preferred embodiment of the present invention.

FIG. 6A to FIG. 6c are schematic diagrams illustrating a first alternative mode of the adjustable rotation base according to the above preferred embodiment of the present invention.

FIG. 7 is a second alternative mode of the adjustable rotation base according to the above preferred embodiment of the present invention.

FIG. 8 is a perspective view of an adjustable rotation base according to a second preferred embodiment of the present invention.

FIG. 9 is an exploded perspective view of an adjustable rotation base according to the above second preferred embodiment of the present invention.

FIG. 10A and FIG. 10B are sectional side views of the adjustable rotation base according to the above second preferred embodiment of the present invention.

FIG. 11A and FIG. 11B are schematic diagrams of a first alternative mode of the adjustable rotation base according to the above second preferred embodiment of the present invention.

FIG. 12 is a second alternative mode of the adjustable rotation base according to the above second preferred embodiment of the present invention.

FIG. 13 is a third alternative mode of the adjustable rotation base according to the above second preferred embodiment of the present invention.

FIGS. 14A and 14B are fourth alternative mode of the adjustable rotation base according to the above preferred embodiment of the present invention.

FIGS. 15A and 15B are fifth alternative mode of the adjustable rotation base according to the above preferred embodiment of the present invention.

### DETAILED DESCRIPTION OF THE PREFERRED EMBODIMENT

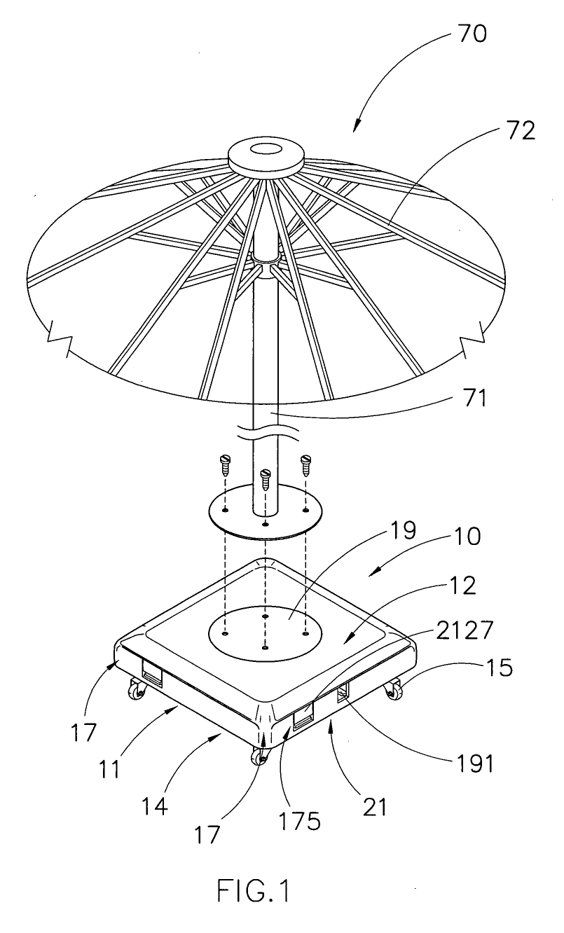

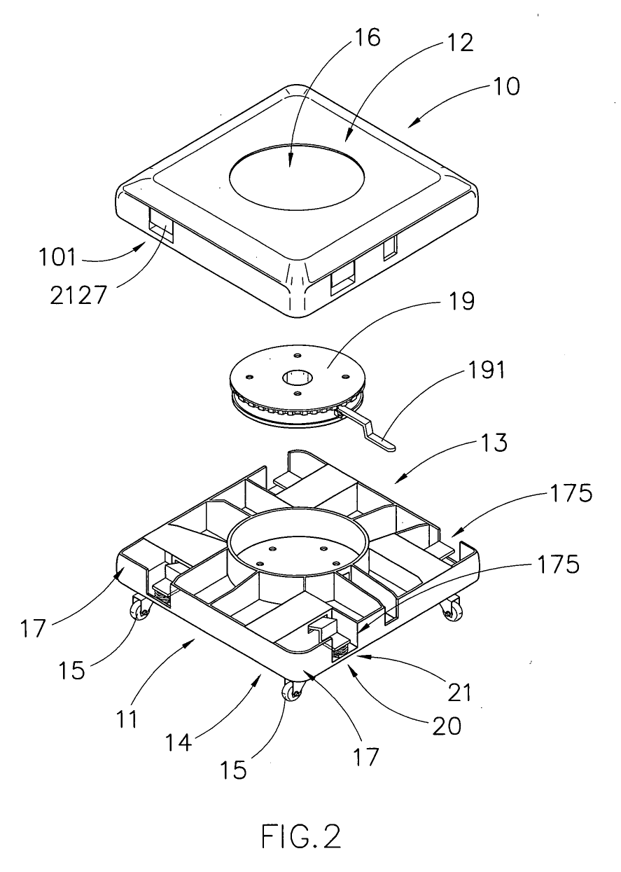

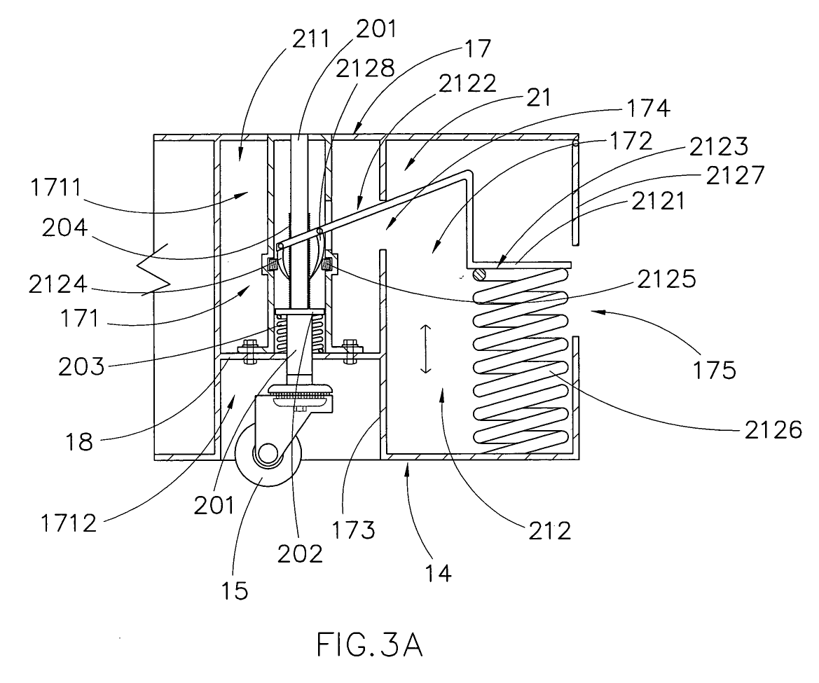

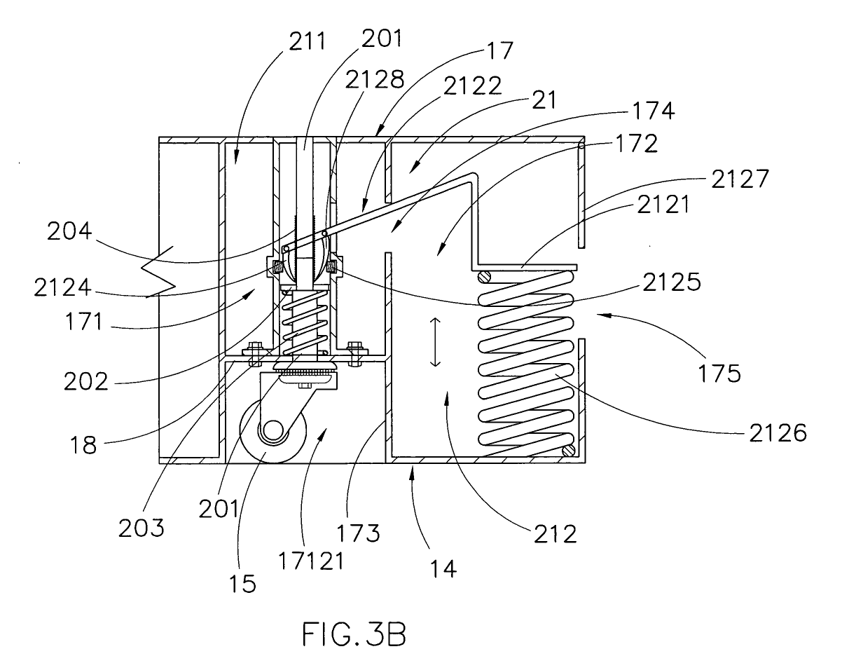

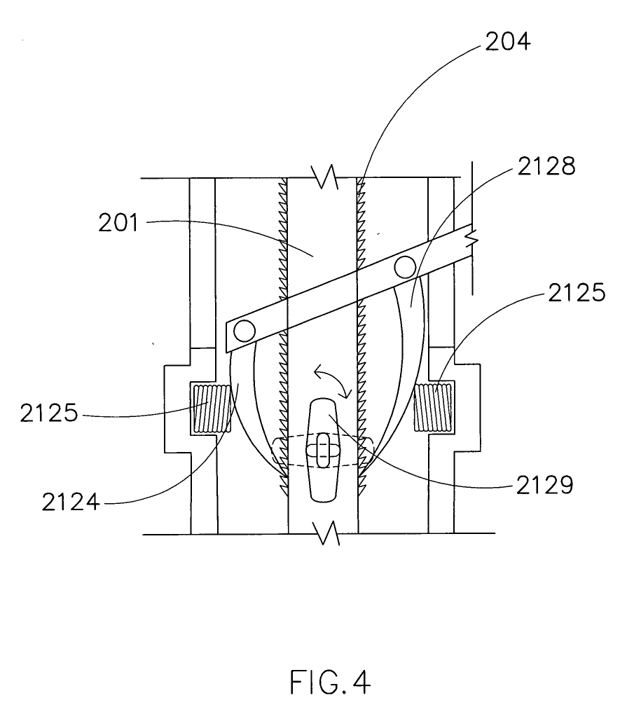

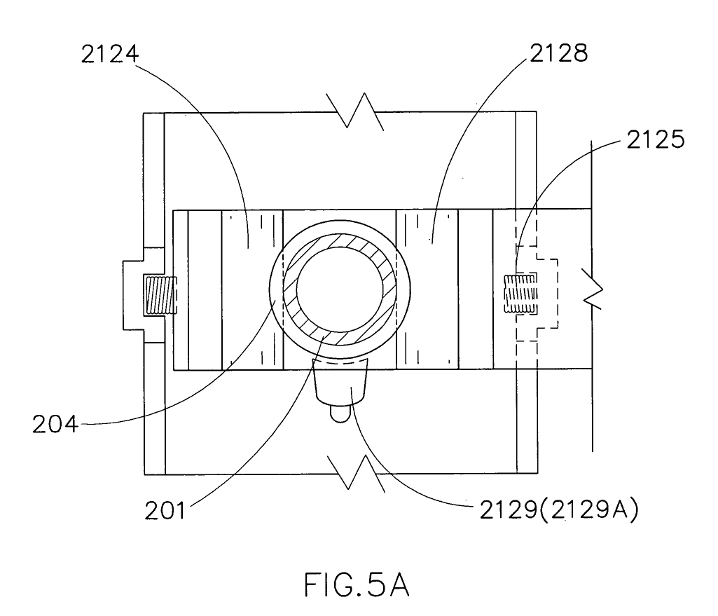

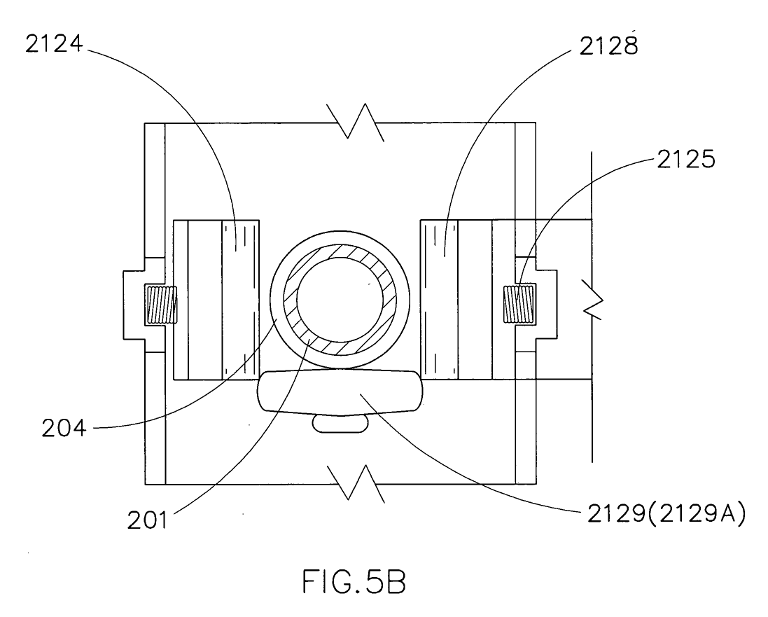

Referring to FIG. 1, FIG. 2, FIG. 3A, FIG. 3B, FIG. 4, FIG. 5A and FIG. 5B of the drawings, an adjustable rotation base for supporting an outdoor umbrella 70 according to a first preferred embodiment of the present invention is illustrated, in which the adjustable rotation base comprises a base housing 10 and a transportation arrangement 20. The outdoor umbrella 70 is meant to be a regular outdoor umbrella 70 which comprises a supporting post 71 extended from a ground surface, and an awning frame 72 extended from the top end portion of the supporting post 71.

The base housing 10 has a bottom side 11, an upper side 12 for coupling with the supporting post 71 to support the outer umbrella 70 in an upright manner, and a receiving cavity 13 indently formed on the bottom side 11 of the base housing 10, wherein the base housing 10 comprises a stationary unit 14 provided at the bottom side 11 for sitting on the ground surface in a station manner, and a plurality of transferring wheels 15 rotatably supported at the bottom side 11 of the base housing 10.

The transportation arrangement 20 is provided at the base housing 10 to operate the base housing 10 between an idle mode and a transportation mode, wherein in the idle mode, the transferring wheels 15 are suspenedly lifted up to define a clearance between the transferring wheels 15 and the ground surface such the base housing 10 is sat on the ground surface via the stationary unit 14 in a stationary manner, wherein in the transportation mode, the stationary unit 14 is upwardly lifted to allow the transferring wheels 15 being sitting on the ground surface, such that the base housing 10 is adapted to be transported on the ground surface via the transferring wheels 15.

According to the preferred embodiment of the present invention, the base housing 10 further has a coupling hole 16 formed at the upper side 11 of the base housing 10 to communicate with the receiving cavity 13, wherein the supporting post 71 of the outdoor umbrella 70 is coupled with the base housing 10 through the coupling hole 16. Moreover, the stationary unit 14 is preferably embodied as bottom surfaces of the base housing 10.

Moreover, the base housing 10 further comprises a rotary support 19 rotatably mounted within the base housing 10, in such a manner that the outdoor umbrella 70 is adapted to couple with the rotary support 19 via the coupling hole 16. Moreover, the base housing 10 further comprises a control pedal 191 extended from the rotary support 19 to an exterior of the base housing 10, so as to selectively control a rotation of the rotary support 19. Thus, when the control pedal 191 is actuated, the rotary support 19 is rotatable with respective to the base housing 10 for adjusting an orientation of the outdoor umbrella 70.

Referring to FIG. 1 to FIG. 2, FIG. 3A, FIG. 3B, FIG. 4, FIG. 5A and FIG. 5B of the drawings, the transportation arrangement 20 comprises a plurality of driving units 21 operatively and spacedly provided in the base housing 10 to mechanically communicate with the transferring wheels 15 respectively, wherein the driving units 21 are adapted to be selectively activated to operate the base housing 10 between the idle mode and the transportation mode.

More specifically, each of the driving units 21 comprises an adjustment assembly 211 mounted in the receiving cavity 13 and a manual actuation unit 212 extended from the adjustment assembly 211 out of the base housing 10 in such a manner that the manual actuation unit 212 is adapted to be manually and selectively operated for driving the adjustment assembly 211 to lift up the base housing 10 with respect to the transferring wheels 15.

Referring to FIG. 3A, FIG. 3B, FIG. 4, FIG. 5A and FIG. 5B of the drawings, the base housing 10 further has a plurality of seat portions 17 formed as four corner portions of the base housing 10, wherein the transferring wheels 15 and the driving units 21 are coupled at the corresponding seat portion 17 for selectively operating the base housing 10 between the idle mode and the transportation mode. Each of the seat portions 17 is divided into a driving compartment 171 and a control compartment 172 by a partitioning wall 173 having a through communication slot 174, wherein the adjustment assembly 211 and the manual actuation unit 212 are mounted in the driving compartment 171 and the control compartment 172 respectively and communicate through the communication slot 174 of the partitioning wall 173. According to the preferred embodiment of the present invention, the base housing 10 further comprises a base panel 18 transversely extended between an inner side of the partitioning wall 173 and an inner side of the opposed sidewall of the driving compartment 171 so as to further divide the driving compartment 171 into an upper compartment chamber 1711 for receiving the adjustment assembly 211 of the corresponding driving unit 21, and a lower compartment chamber 1712 for receiving the transferring wheels 15.

For each of the driving units 21, the adjustment assembly 211 comprises a connecting shaft 201, having a lower end portion connected with the corresponding transferring wheel 15, longitudinally extended within the driving compartment 171 of the base housing 10, a biasing member 202 outwardly extended from the connecting shaft 201 within the upper compartment chamber 1711 at a position which is spacedly apart from an upper surface of the base panel 18, and a resilient element 203 disposed between the base panel 18 and the biasing member 202 to normally exert an upward urging force toward the connecting shaft 201 so as to normally retain the corresponding transferring wheel 15 within the lower compartment chamber 1712.

Moreover, each of the adjustment assemblies 211 further comprises a plurality of locking teeth 204 formed an outer side of the connecting shaft 201 for engaging with the corresponding manual actuation unit 212 of the driving unit 21. Accordingly, each of the manual actuation units 212 comprises an actuation pedal 2121, having a driving end portion 2122 and an actuation end portion 2123, extended from the adjustment assembly 211 to the control compartment 172 of the seat portion 17 through the communication slot 174 of the partitioning wall 173, a first and a second locking members 2124, 2128 pivotally and downwardly extended from the actuation end portion 2123 of the actuation pedal 2121 for selectively engaging with the locking teeth 204 of the corresponding driving assembly 211. In order to normally retain engagement between the locking teeth 204 and the locking members 2124, the manual actuation unit 212 further comprises a plurality of retention springs 2125 mounted within the upper compartment chamber 1711 of the driving compartment 171 to normally bias against the locking members 2124 respectively so as to make the locking members 2124 normally engaging with the locking teeth 204 for restricting a lateral movement between the connecting shaft 201 and the actuation pedal 2121.

As shown in FIG. 3A and FIG. 3B of the drawings, each of the manual actuation units 212 further comprises a resilient member 2126 mounted in the control compartment 172 of the corresponding seat portion 17 of the base housing 10 to normally exert an upward urging force toward the actuation end portion 2123 of the actuation pedal 2121, which is adapted for being stepped on by a user of the present invention. Thus, when the user steps on the actuation end portion 2123 of the actuation pedal 2121, the actuation pedal 2121 is depressed so as to compress the resilient member 2126 mounted underneath the actuation end portion 2123 of the actuation pedal 2121. Conversely, when the depression force is released (i.e. the user stops stepping onto the actuation pedal 2121), the actuation end portion 2123 of the actuation pedal 2121 is restored to its original position with the resilient member 2126 decompressed.

In order to access the driving units 21 from an exterior of the base housing 10, the base housing 10 further has a plurality of wheels control slot 175 formed on the seat portions 17 of the base housing respectively to communicate with the control compartments 172 for allowing users to access the driving units 21 via the wheels control slot 175. In order that the transportation arrangement 20 does not affect the aesthetic appearance of the entire outdoor umbrella structure, each of the manual activation units 212 further comprises a pedal cover 2127 pivotally mounted to the base housing 10 at a top side edge of the corresponding wheels control slot 175 in an inwardly flappable manner, so that the pedal cover 2127 is arranged to normally cover the corresponding wheels control slot 175, and when the user wishes to access the driving units 21 from exterior of the base housing 10, he or she needs only to inwardly push the pedal cover 2127 into the control compartment 172 which then allows access to the actuation end portion 2123 of the actuation pedal 2121. The user is then able to step onto the actuation end portion 2123 of the actuation pedal 2121.

The operation of each of the driving units 21 is as follows: when the actuation end portion 2123 of the actuation pedal 2121 is depressed, the first locking member 2124 is also depressed to drive the connecting shaft 201 to move downwardly for a predetermined distance as dictated by the displacement of the driving end portion 2122 of the actuation pedal 2121. When the actuation end portion 2123 of the actuation pedal 2121 is depressed to its maximum displacement (i.e. when the resilient member 2126 is compressed to its maximum extent) the user is unable to further depress the actuation end portion 2123 of the actuation pedal 2121. At this stage, the user should release the depression force to the actuation pedal 2121 which is then rebounded to its original position by the resilient member 2126. When the actuation end portion 2123 of the actuation pedal 2121 is rebounded, the engagement between the second locking member 2128 and the locking teeth 204 prevents the connecting shaft 201 from being driven to move upwardly so as to retain the position thereof. As such, the user is able to depress the actuation end portion 2123 of the actuation pedal 2121 for several times so as to incrementally lower the position of the corresponding transferring wheel 15 until it is lowered to stand on the ground surface for suspending supporting the base housing 10 and the outdoor umbrella 70. When the four transferring wheels 15 are sequentially lowered, the user is able to transport the outdoor umbrella 70 by the transferring wheels 15.

It is worth mentioning that the locking members 2124, 2128 are selectively engaged with the locking teeth 204 such that when the locking members 2124, 2128 are selectively disengaged from the locking teeth 204, the connecting shaft 201 is pushed upwardly by the resilient element 203 and the transferring wheel 15 is then pushed to restore to its original position (i.e. received into the base housing 10). Accordingly, each of the manual activation units 212 further comprises an adjusting screw 2129 rotatably provided on the base housing 10 to communicate with the first and the second locking member 2124, 2128, in such a manner that the adjusting screw 2129 is adapted to selectively engage and disengage the locking member 2124, 2128 with and from the locking teeth 204 respectively.

Moreover, in order further enhance the stability of the base housing 10, the base housing 10 further comprises a stabilizing agent filled therewithin for substantially increasing the weight of the base housing 10. The stabilizing agent is preferably a predetermined amount of sands or water having a relatively high density among other objects.

It is worth mentioning that as a slight alternative of this third alternative mode, the base housing 10 may further comprise a supporting panel wherein the transferring wheels 15 are attached onto the supporting panel. The supporting shaft 201 is connected with the supporting panel in such a manner that when the supporting shaft 201 is driven to move longitudinally, the supporting panel is also driven to move correspondingly and therefore lifting up or lowering down the transferring wheels 15.

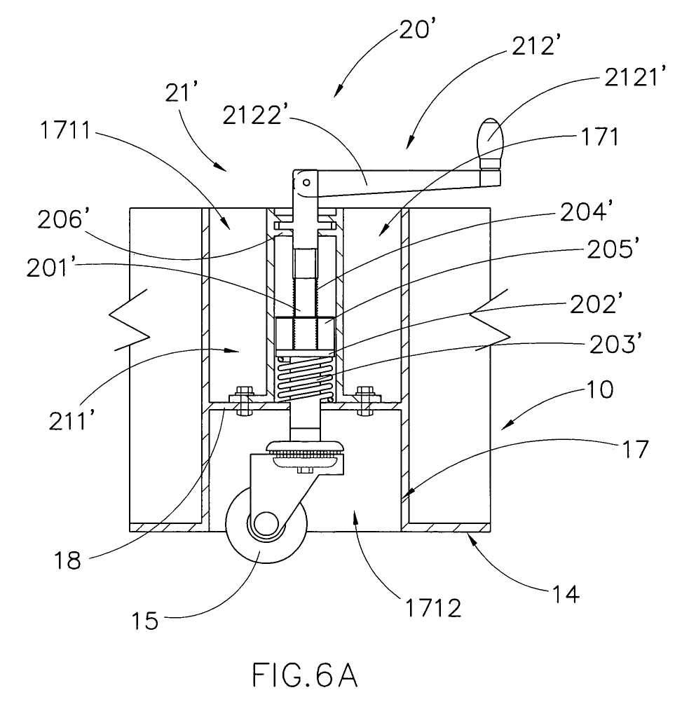

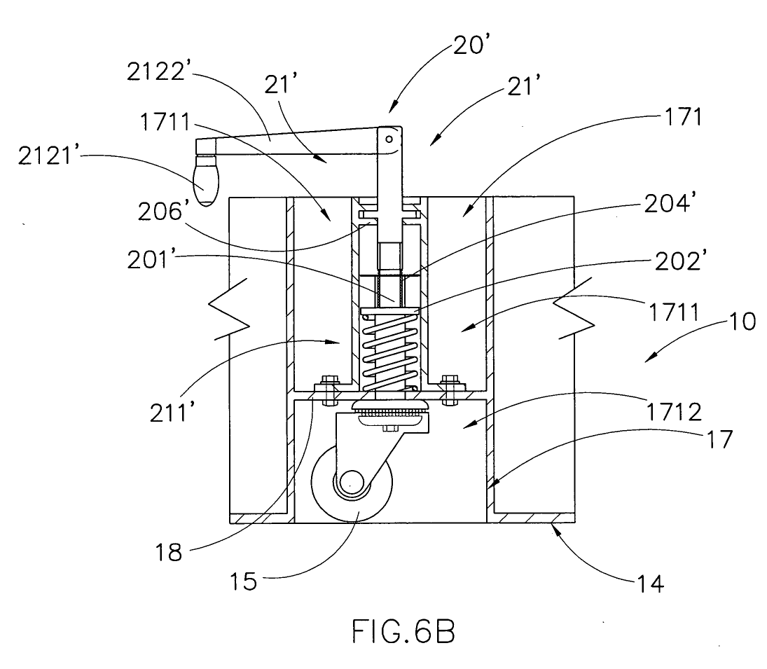

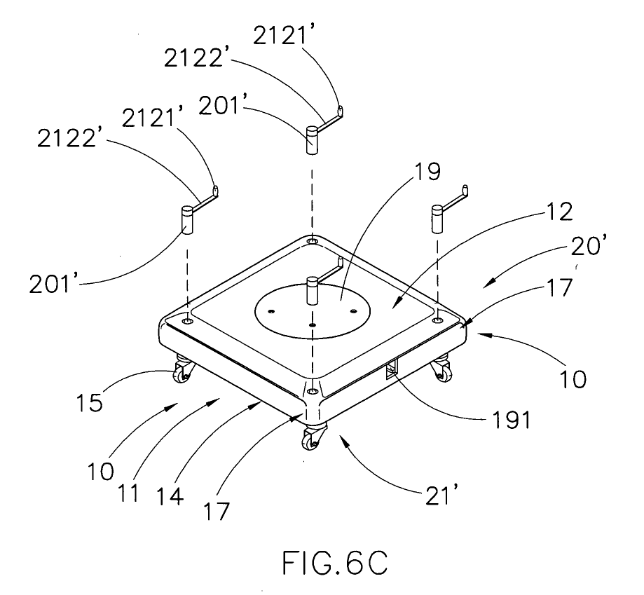

Referring to FIG. 6A to FIG. 6C of the drawings, an alternative mode of the adjustable rotation base according to the above preferred embodiment of the present invention is illustrated. The first alternative mode is similar to the preferred embodiment except the transportation arrangement 20′. According to the first alternative mode, the transportation arrangement 20′ comprises a plurality of driving units 21′ operatively and spacedly provided in the base housing 10 to mechanically communicate with the transferring wheels 15 respectively, wherein the driving units 21′ are adapted to be selectively activated to operate the base housing 10 between the idle mode and the transportation mode.

More specifically, each of the driving units 21′ comprises an adjustment assembly 211′ mounted in the receiving cavity 13 and a manual actuation unit 212′ extended from the adjustment assembly 211 ′ out of the base housing 10 in such a manner that the manual actuation unit 212′ is adapted to be manually and selectively operated for driving the adjustment assembly 211′ to lift up the base housing 10 with respect to the transferring wheels 15.

For each of the driving units 21′, the adjustment assembly 211′ comprises a connecting shaft 201′, having a lower end portion communicating with the corresponding transferring wheel 15, longitudinally extended within the driving compartment 171 of the base housing 10, a biasing member 202′ outwardly extended from the connecting shaft 201′ within the upper compartment chamber 1711 at a position which is spacedly apart from an upper surface of the base panel 18, and a resilient element 203′ disposed between the base panel 18 and the biasing member 202′ to normally exert an upward urging force toward the connecting shaft 201′ so as to normally retain the corresponding transferring wheel 15 within the lower compartment chamber 1712.

According to the first alternative mode, the adjustment assembly 211′ further comprises a rotary member 205′ movably provided within the driving compartment 171 of the corresponding seat portion 17 of the base housing 10 to engage with the lower end portion of the connecting shaft 201′. More specifically, the rotary member 205′ has a circular, ring-shaped cross section, wherein the rotary member 205′ has a threaded inner surface for forming a plurality of screwing teeth 2051′ on the inner surface of the rotary member 205′. On the other hand, the connecting shaft 201′ further has a plurality of teeth 204′ formed thereon to engage with the threaded inner surface of the rotary member 205′, in such a manner that when the connecting shaft 201′ is driven to rotate, the rotary member 205′ is also driven to rotate so as to initiate a linear movement within the driving compartment 171 of the base housing 10.

Referring to FIG. 6A to FIG. 6B of the drawings, the driving assembly 211′ further comprises a shaft holder 206′ provided on the upper compartment chamber 1711 of the base housing 10 for retaining a longitudinal movement of the connecting shaft 201′ within the upper compartment chamber 1711. Thus, when the connecting shaft 201′ is driven to rotate in a predetermined direction, the rotary member 205′ is also driven to rotate in such a manner that the rotary member 205′ travels downwardly and longitudinally along the connecting shaft 201′ to bias against the biasing member 202′ which then lowers the corresponding transferring wheel 15 and compress the resilient element 203′.

On the other hand, the manual activation unit 212′ comprises a handle member 2121′ extended out of the base housing 10 in a rotatably movable manner, and an actuation rod 2122′ extended from an upper end portion of the connecting shaft 201′ to the handling member 2121′. Thus, when the handle member 2121′ is driven to rotate in a predetermined direction, the connecting shaft 201′ is also driven to rotate for lowering the corresponding transferring wheel 15 by the descending movement of the rotary member 205′. When all of the transferring wheels 15 are descended to a position underneath the base housing 10, the outdoor umbrella is readily transported by the transferring wheels 15. When the user wishes to restore the position of the transferring wheel 15, he or she simply needs to rotate the handle member 2121′ in an opposed direction for screwing the rotary member 205′ in that corresponding direction. Thus, the rotary member 205′ is adapted to displace upwardly along the connecting shaft 201′ for receiving into the base housing 10.

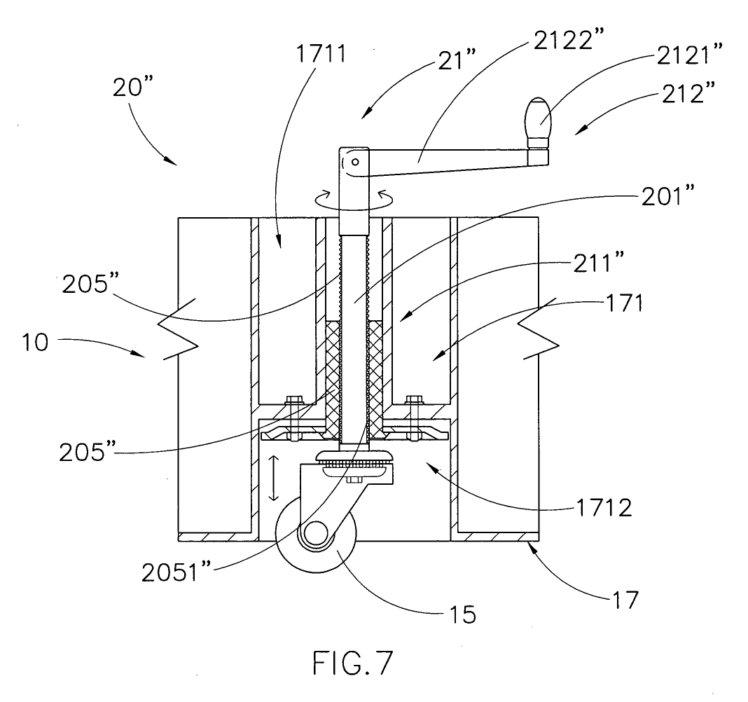

Referring to FIG. 7 of the drawings, a second alternative mode of the adjustable rotation base according to the preferred embodiment of the present invention is illustrated. The second alternative mode is similar to the preferred embodiment except the transportation arrangement 20″. According to the second alternative mode, the transportation arrangement 20″ comprises a plurality of driving units 21″ operatively and spacedly provided in the base housing 10 to mechanically communicate with the transferring wheels 15 respectively, wherein the driving units 21″ are adapted to be selectively activated to operate the base housing 10 between the idle mode and the transportation mode.

Each of the driving units 21″ comprises an adjustment assembly 211″ mounted in the receiving cavity 13 and a manual actuation unit 212″ extended from the adjustment assembly 211″ out of the base housing 10 in such a manner that the manual actuation unit 212″ is adapted to be manually and selectively operated for driving the adjustment assembly 211″ to lift up the base housing 10 with respect to the transferring wheels 15.

For each of the driving units 21″, the adjustment assembly 211″ comprises a connecting shaft 201″, having a lower end portion directly connecting with the corresponding transferring wheel 15, longitudinally extended within the driving compartment 171 of the base housing 10.

According to the second alternative mode, the adjustment assembly 211″ further comprises a rotary member 205″ securely provided within the driving compartment 171 of the corresponding seat portion 17 of the base housing 10 to engage with the lower end portion of the connecting shaft 201″. More specifically, the rotary member 205″ has a circular, ring-shaped cross section, wherein the rotary member 205″ has a threaded inner surface for forming a plurality of screwing teeth 2051″ on the inner surface of the rotary member 205′. On the other hand, the connecting shaft 201″ further has a plurality of teeth 204″ formed thereon to engage with the threaded inner surface of the rotary member 205″, in such a manner that when the connecting shaft 201″ is driven to rotate, the connecting shaft 201″ also displaces longitudinally along the driving compartment 171 to initiate a linear movement of the transferring wheel 15.

On the other hand, each of the manual actuation unit 212″ comprises a handle member 2121″ extended out of the base housing 10 in a rotatably movable manner, and a actuation rod 2122″ extended from an upper end portion of the connecting shaft 201″ to the handling member 2121″. Thus, when the handle member 2121″ is driven to rotate in a predetermined direction, the connecting shaft 201″ is also driven to rotate for lowering the corresponding transferring wheel 15 by the descending movement of the rotary member 205″.

When all of the transferring wheels 15 are descended to a position underneath the base housing 10, the outdoor umbrella is readily transported by the transferring wheels 15. When the user wishes to restore the position of the transferring wheel 15, he or she simply needs to rotate the handle member 2121″ in an opposed direction for rotating the connecting shaft 201″ in that corresponding direction, which is then adapted to displace upwardly along the driving compartment 17 for receiving the transferring wheel 15 back into the base housing 10 so that the outdoor umbrella 70 is supported by the stationary unit 14.

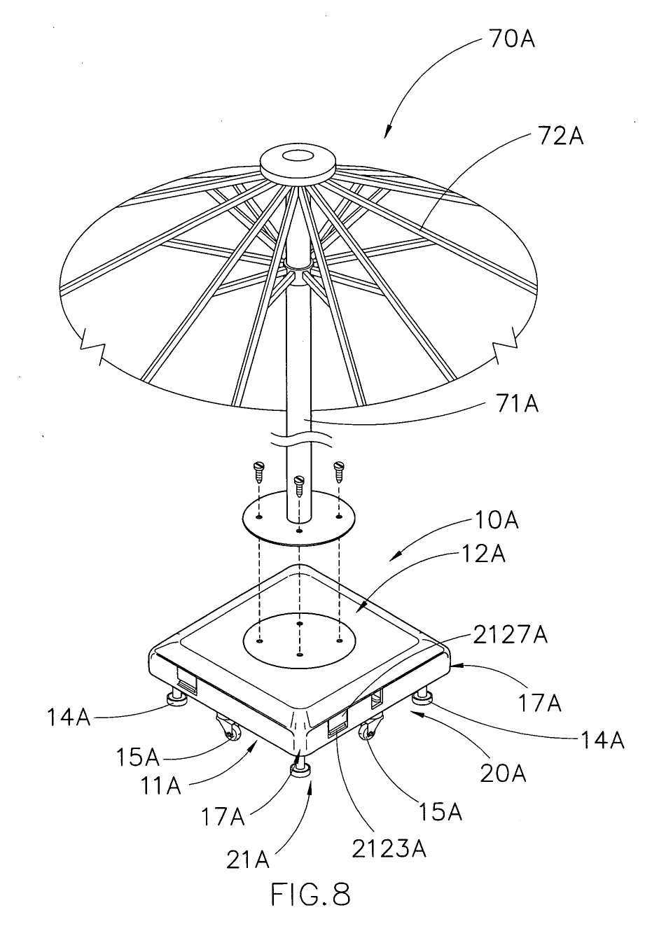

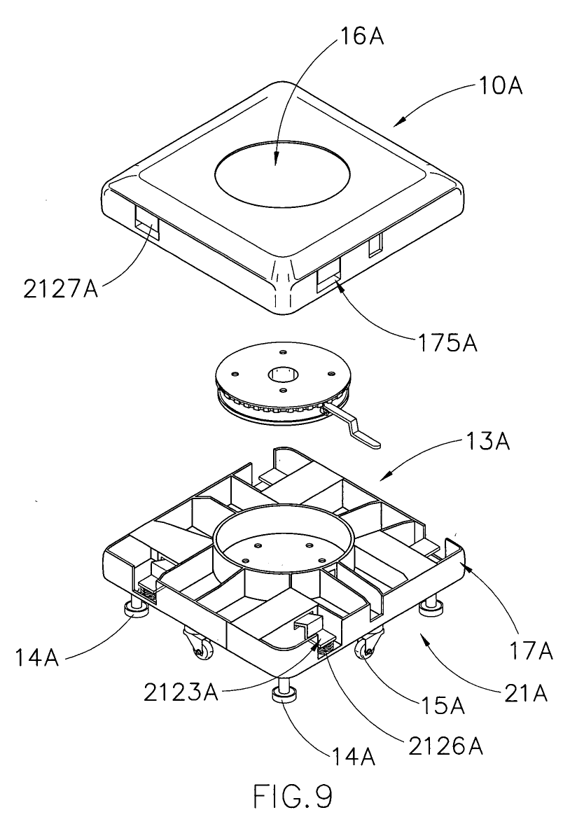

Referring to FIG. 8 to FIG. 9 of the drawings, an adjustable rotation base for supporting an outdoor umbrella 70A according to second preferred embodiment of the present invention is illustrated, in which the adjustable rotation base comprises a base housing 10A and a transportation arrangement 20A. The outdoor umbrella 70A is meant to be a regular outdoor umbrella 70A which comprises a supporting post 71A extended from a ground surface, and an awning frame extended from the top end portion of the supporting post 71A.

The base housing 10A has a bottom side I IA, an upper side 12A for coupling with the supporting post 71A to support the outer umbrella 70A in an upright manner, and a receiving cavity 13A indently formed on the bottom side 11A of the base housing 10A, wherein the base housing 10A comprises at least one stationary unit 14A provided at the bottom side 11A for sitting on the ground surface in a station manner, and a plurality of transferring wheels 15A rotatably supported at the bottom side 11A of the base housing 10A.

The transportation arrangement 20A is provided at the base housing 10A to operate the base housing 10A between an idle mode and a transportation mode, wherein in the idle mode, the transferring wheels 15A are suspenedly lifted up to define a clearance between the transferring wheels 15A and the ground surface such the base housing 10A is sat on the ground surface via the stationary unit 14A in a stationary manner, wherein in the transportation mode, the stationary unit 14A is upwardly lifted to allow the transferring wheels 15A being sitting on the ground surface, such that the base housing 10A is adapted to be transported on the ground surface via the transferring wheels 15A.

According to the preferred embodiment of the present invention, the base housing further has a coupling hole 16A formed at the upper side 11A of the base housing 10A to communicate with the receiving cavity 13A, wherein the supporting post 71A of the outdoor umbrella 70A is coupled with the base housing 10A through the coupling hole 16A. Each of the stationary units 14A is preferably embodied as a three-dimensional supporting member adapted to normally rest on the ground surface.

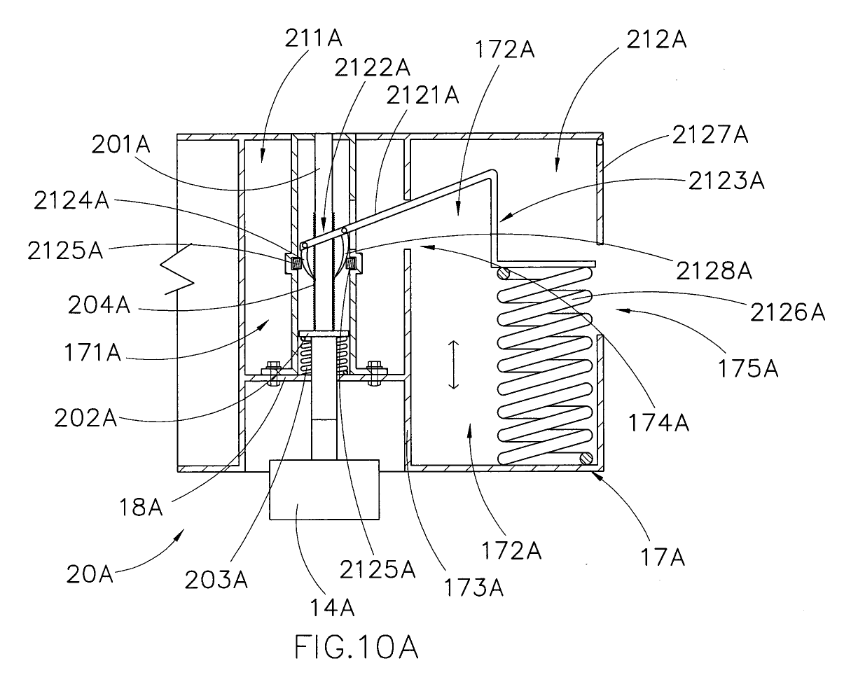

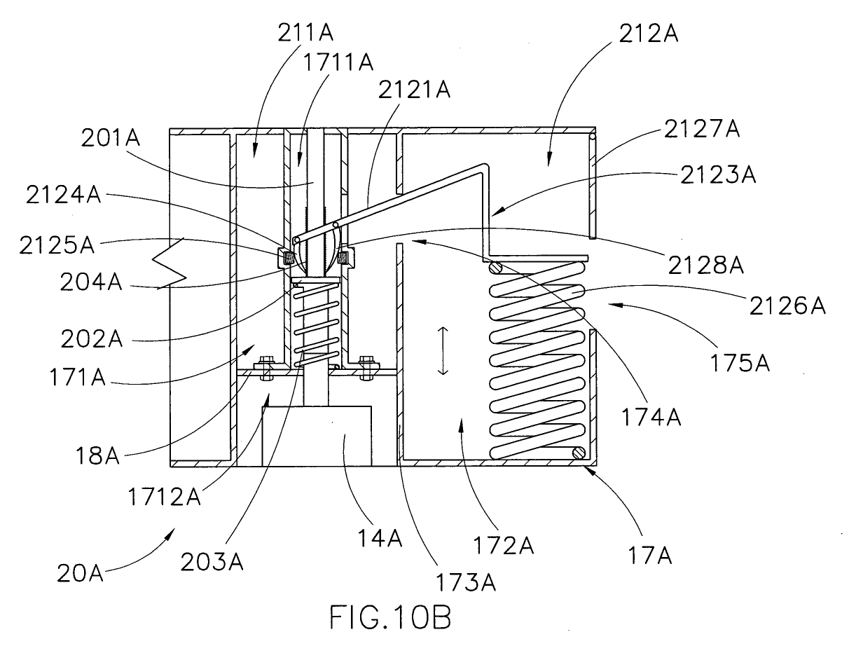

Referring to FIG. 8 to FIG. 9, FIG. 10A and FIG. 10B of the drawings, the transportation arrangement 20A comprises a plurality of driving units 21A operatively and spacedly provided in the base housing 10A to mechanically communicate with the stationary units 14A respectively, wherein the driving units 21A are adapted to be selectively activated to operate the base housing 10A between the idle mode and the transportation mode.

More specifically, each of the driving units 21A comprises an adjustment assembly 211A mounted in the receiving cavity 13A and a manual actuation unit 212A extended from the adjustment assembly 211A out of the base housing 10 in such a manner that the manual actuation unit 212A is adapted to be manually and selectively operated for driving the adjustment assembly 211A to lift up the base housing 10A with respect to the ground surface.

Referring to FIG. 10A and FIG. 10B of the drawings, the base housing 10A further has a plurality of seat portions 17A formed as four corner portions of the base housing 10A, wherein the stationary units 14A and the driving units 21A are coupled at the corresponding seat portion 17A for selectively operating the base housing 10A between the idle mode and the transportation mode. Each of the seat portions 17A is divided into a driving compartment 171A and a control compartment 172A by a partitioning wall 173A having a through communication slot 174A, wherein the adjustment assembly 211A and the manual actuation unit 212A are mounted in the driving compartment 171A and the control compartment 172A respectively and communicate through the communication slot 174A of the partitioning wall 173A. According to the second preferred embodiment of the present invention, the base housing 10A further comprises a base panel 18A transversely extended between an inner side of the partitioning wall 173A and an inner side of the opposed sidewall of the driving compartment 171A so as to further divide the driving compartment 171A into an upper compartment chamber 1711A for receiving the adjustment assembly 211A of the corresponding driving unit 21A, and a lower compartment chamber 1712A for receiving the stationary unit 14A.

For each of the driving units 21A, the adjustment assembly 211A comprises a connecting shaft 201A, having a lower end portion connected with the corresponding stationary unit 14A, longitudinally extended within the driving compartment 171A of the base housing 10A, a biasing member 202A outwardly extended from the connecting shaft 201A within the upper compartment chamber 1711A at a position which is spacedly apart from an upper surface of the base panel 18A, and a resilient element 203A disposed between the base panel 18A and the biasing member 202A to normally exert an upward urging force toward the connecting shaft 201A so as to normally retain the corresponding stationary unit 14A within the lower compartment chamber 1712A.

Moreover, each of the adjustment assemblies 211A further comprises a plurality of locking teeth 204A formed an outer side of the connecting shaft 201A for engaging with the corresponding manual actuation unit 212A of the driving unit 21A. Accordingly, each of the manual actuation units 212A comprises an actuation pedal 2121A, having a driving end portion 2122A and an actuation end portion 2123A, extended from the adjustment assembly 211A to the control compartment 172A of the seat portion 17A through the communication slot 174A of the partitioning wall 173A, a first and a second locking members 2124A, 2128A pivotally and downwardly extended from the actuation end portion 2123A of the actuation pedal 2121A for selectively engaging with the locking teeth 204A of the corresponding driving assembly 211A. In order to normally retain engagement between the locking teeth 204A and the locking members 2124A, the manual actuation unit 212A further comprises a plurality of retention springs 2125A mounted within the upper compartment chamber 1711A of the driving compartment 171A to normally bias against the locking members 2124A respectively so as to make the locking members 2124A normally engaging with the locking teeth 204A for restricting a lateral movement between the connecting shaft 201A and the actuation pedal 2121A.

As shown in FIG. 10A and FIG. 10B of the drawings, each of the manual actuation units 212A further comprises a resilient member 2126A mounted in the control compartment 172A of the corresponding seat portion 17A of the base housing 10A to normally exert an upward urging force toward the actuation end portion 2123A of the actuation pedal 2121A, which is adapted for being stepped on by a user of the present invention. Thus, when the user steps on the actuation end portion 2123A of the actuation pedal 2121A, the actuation pedal 2121A is depressed so as to compress the resilient member 2126A mounted underneath the actuation end portion 2123A of the actuation pedal 2121A. Conversely, when the depression force is released (i.e. the user stops stepping onto the actuation pedal 2121A), the actuation end portion 2123A of the actuation pedal 2121A is restored to its original position with the resilient member 2126A decompressed.

In order to access the driving units 21A from an exterior of the base housing 10A, the base housing 10A further has a plurality of wheels control slot 175A formed on the seat portions 17A of the base housing respectively to communicate with the control compartments 172A for allowing users to access the driving units 21A via the wheels control slot 175A. In order that the transportation arrangement 20A does not affect the aesthetic appearance of the entire outdoor umbrella structure, each of the manual activation units 212A further comprises a pedal cover 2127A pivotally mounted to the base housing 10A at a top side edge of the corresponding wheels control slot 175A in an inwardly flappable manner, so that the pedal cover 2127A is arranged to normally cover the corresponding wheels control slot 175A, and when the user wishes to access the driving units 21A from exterior of the base housing 10A, he or she needs only to inwardly push the pedal cover 2127A into the control compartment 172A which then allows access to the actuation end portion 2123A of the actuation pedal 2121A. The user is then able to step onto the actuation end portion 2123A of the actuation pedal 2121A.

The operation of each of the driving units 21A is as follows: when the actuation end portion 2123A of the actuation pedal 2121A is depressed, the first locking member 2124A is also depressed to drive the connecting shaft 201A to move downwardly for a predetermined distance as dictated by the displacement of the driving end portion 2122A of the actuation pedal 2121A. When the actuation end portion 2123A of the actuation pedal 2121A is depressed to its maximum displacement (i.e. when the resilient member 2126A is compressed to its maximum extent) the user is unable to further depress the actuation end portion 2123A of the actuation pedal 2121A. At this stage, the user should release the depression force to the actuation pedal 2121A which is then rebounded to its original position by the resilient member 2126A. When the actuation end portion 2123A of the actuation pedal 2121A is rebounded, the engagement between the second locking member 2128A and the locking teeth 204A prevents the connecting shaft 201A from being driven move upwardly so as to retain the position thereof. As such, the user is able to depress the actuation end portion 2123A of the actuation pedal 2121A for several times so as to incrementally lower the position of the corresponding stationary unit 14A until it is lowered to stand on the ground surface for suspending supporting the base housing 10A and the outdoor umbrella 70A. When the four stationary units 14A are sequentially lowered, the base housing 10A is arranged to securely stand on the ground surface (i.e. idle mode).

It is worth mentioning that the locking members 2124A, 2128A are selectively engaged with the locking teeth 204A such that when the locking members 2124A, 2128A are selectively disengaged from the locking teeth 204A, the connecting shaft 201A is pushed upwardly by the resilient element 203A and the stationary unit 14A is then pushed to restore to its original position (i.e. received into the base housing 10A). Accordingly, each of the manual activation units 212A further comprises an adjusting screw 2129A (as shown in FIG. 5A and FIG. 5B of the drawings) rotatably provided on the base housing 10A to connect with the first and the second locking member 2124A, 2128A, in such a manner that the adjusting screw 2129A is adapted to selectively engage and disengage the locking member 2124A, 2128A with and from the locking teeth 204A respectively. When the stationary units 14A are all received into the base housing 10A, the transferring wheels 15A are positioned underneath the stationary units 14A and left to stand on the ground surface. As a result, a user is able to transport the outdoor umbrella 70A via the transferring wheels (i.e. transportation mode).

Moreover, in order further enhance the stability of the base housing 10A, the base housing 10A further comprises a stabilizing agent filled therewithin for substantially increasing the weight of the base housing 10A. The stabilizing agent is preferably a predetermined amount of sand or water having a relatively high density among other objects.

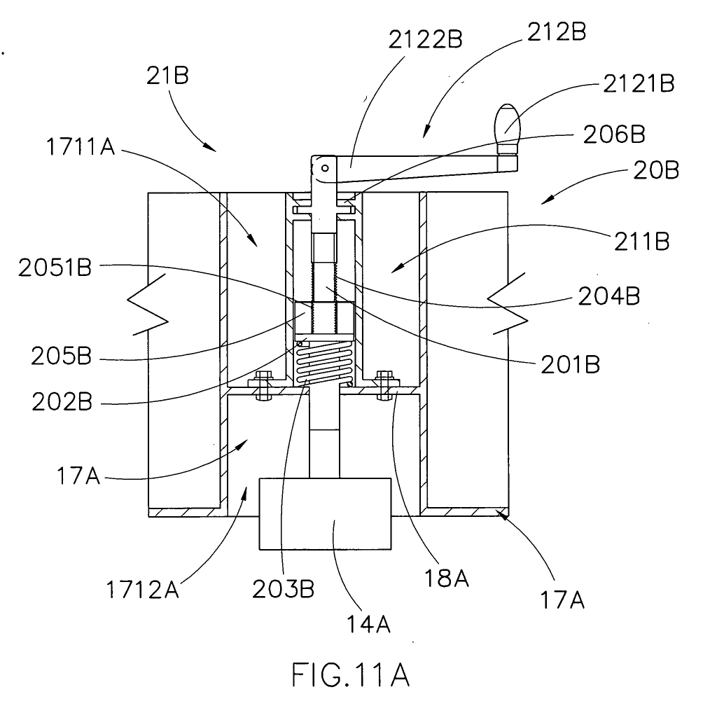

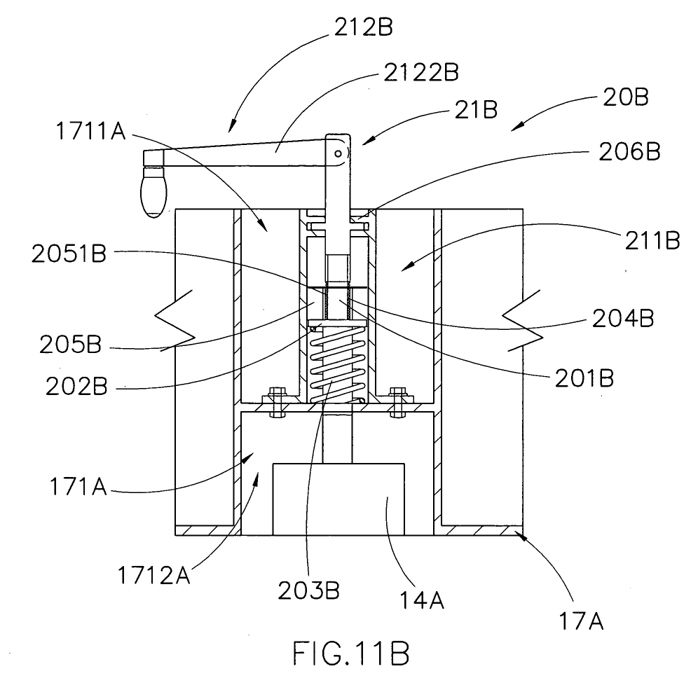

Referring to FIG. 11A to FIG. 11B of the drawings, a first alternative mode of the adjustable rotation base according to the above second preferred embodiment of the present invention is illustrated. The first alternative mode is similar to the preferred embodiment except the transportation arrangement 20B. According to the first alternative mode, the transportation arrangement 20B comprises a plurality of driving units 21B operatively and spacedly provided in the base housing 10A to mechanically communicate with the stationary units 14A respectively, wherein the driving units 21B are adapted to be selectively activated to operate the base housing 10A between the idle mode and the transportation mode.

More specifically, each of the driving units 21B comprises an adjustment assembly 211B mounted in the receiving cavity 13A and a manual actuation unit 212B extended from the adjustment assembly 211B out of the base housing 10A in such a manner that the manual actuation unit 212B is adapted to be manually and selectively operated for driving the adjustment assembly 21B to lift up the base housing 10A with respect to the ground surface.

For each of the driving units 21B, the adjustment assembly 211B comprises a connecting shaft 201B, having a lower end portion communicating with the corresponding stationary unit 14A, longitudinally extended within the driving compartment 171A of the base housing 10A, a biasing member 202B outwardly extended from the connecting shaft 201B within the upper compartment chamber 1711A at a position which is spacedly apart from an upper surface of the base panel 18A, and a resilient element 203B disposed between the base panel 18A and the biasing member 202B to normally exert an upward urging force toward the connecting shaft 201B so as to normally retain the corresponding stationary unit 14A within the lower compartment chamber 1712A.

According to the first alternative mode, the adjustment assembly 211B further comprises a rotary member 205B movably provided within the driving compartment 171A of the corresponding seat portion 17A of the base housing 10A to engage with the lower end portion of the connecting shaft 201B. More specifically, the rotary member 205B has a circular, ring-shaped cross section, wherein the rotary member 205B has a threaded inner surface for forming a plurality of screwing teeth 2051B on the inner surface of the rotary member 205B. On the other hand, the connecting shaft 201B further has a plurality of teeth 204B formed thereon to engage with the threaded inner surface of the rotary member 205B, in such a manner that when the connecting shaft 201B is driven to rotate, the rotary member 205B is also driven to rotate so as to initiate a linear movement thereof within the driving compartment 171A of the base housing 10A.

Referring to FIG. 11A to FIG. 11B of the drawings, the driving assembly 211B further comprises a shaft holder 206B provided on the upper compartment chamber 1711A of the base housing 10A for retaining a longitudinal movement of the connecting shaft 201B within the upper compartment chamber 1711A. Thus, when the connecting shaft 201B is driven to rotate in a predetermined direction, the rotary member 205B is also driven to rotate in such a manner that the rotary member 205B travels downwardly and longitudinally along the connecting shaft 201B to bias against the biasing member 202B which then lowers the corresponding stationary unit 14A and compress the resilient element 203B.

On the other hand, the manual activation unit 212B comprises a handle member 2121B extended out of the base housing 10A in a rotatably movable manner, and a actuation rod 2122B extended from an upper end portion of the connecting shaft 201B to the handling member 2121B.

Thus, when the handle member 2121B is driven to rotate in a predetermined direction, the connecting shaft 201B is also driven to rotate for lowering the corresponding stationary unit 14A by the descending movement of the rotary member 205B. When all of the stationary units 14A are descended to a position underneath the base housing 10A, the outdoor umbrella 70A is arranged to securely stand on the ground surface.

Conversely, when the user wishes to restore the position of the stationary units 14A, he or she simply needs to rotate the handle member 2121B in an opposed direction for screwing the rotary member 205B in that corresponding direction. Thus, the rotary member 205B is adapted to displace upwardly along the connecting shaft 201B for receiving into the base housing 10A with the assistance of the resilient member 2126B. When all the stationary units 14A are received into the base housing 10A so that the transferring wheels 15A are positioned underneath the stationary units 14A, the outdoor umbrella is readily transported by the transferring wheels 15A.

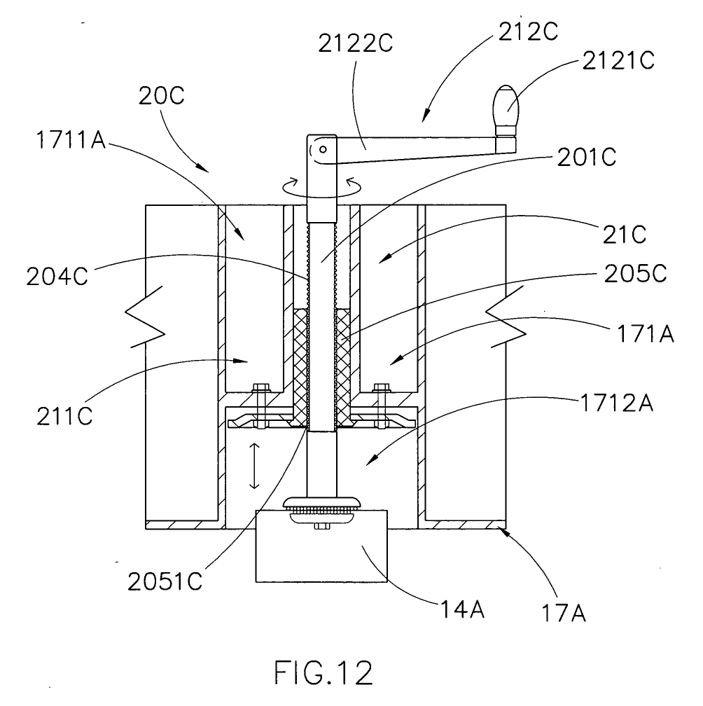

Referring to FIG. 12 of the drawings, a second alternative mode of the adjustable rotation base according to the preferred embodiment of the present invention is illustrated. The second alternative mode is similar to the preferred embodiment except the transportation arrangement 20C. According to the second alternative mode, the transportation arrangement 20C comprises a plurality of driving units 21C operatively and spacedly provided in the base housing 10A to mechanically communicate with the stationary units 14A respectively, wherein the driving units 21C are adapted to be selectively activated to operate the base housing 10A between the idle mode and the transportation mode.

Each of the driving units 21C comprises an adjustment assembly 211C mounted in the receiving cavity 13A and a manual actuation unit 212C extended from the adjustment assembly 211C out of the base housing 10 in such a manner that the manual actuation unit 212C is adapted to be manually and selectively operated for driving the adjustment assembly 211C to lift up the base housing 10A with respect to the ground surface.

For each of the driving units 21C, the adjustment assembly 211C comprises a connecting shaft 201C, having a lower end portion directly connecting with the corresponding stationary unit 14A, longitudinally extended within the driving compartment 171A of the base housing 10A.

According to the second alternative mode, the adjustment assembly 211C further comprises a rotary member 205C securely provided within the driving compartment 171A of the corresponding seat portion 17A of the base housing 10A to engage with the lower end portion of the connecting shaft 201C. More specifically, the rotary member 205C has a circular, ring-shaped cross section, wherein the rotary member 205C has a threaded inner surface for forming a plurality of screwing teeth 2051C on the inner surface of the rotary member 205C. On the other hand, the connecting shaft 201C further has a plurality of teeth 204C formed thereon to engage with the threaded inner surface of the rotary member 205C, in such a manner that when the connecting shaft 201C is driven to rotate, the connecting shaft 201C also displaces longitudinally along the driving compartment 171A to initiate a linear movement of the stationary unit 14A.

On the other hand, each of the manual actuation unit 212C comprises a handle member 2121C extended out of the base housing 10A in a rotatably movable manner, and a actuation rod 2122C extended from an upper end portion of the connecting shaft 201C to the handling member 2121C. Thus, when the handle member 2121C is driven to rotate in a predetermined direction, the connecting shaft 201C is also driven to rotate for lowering the corresponding stationary unit 14A by the descending movement of the connecting shaft 201C.

When all of the stationary units 14A are descended to a position underneath the base housing 10, the outdoor umbrella is securely supported by the stationary units 14A and is arranged to securely stand on a ground surface (i.e. the idle mode). When the user wishes to restore the position of the stationary unit 14A, he or she simply needs to rotate the handle member 2121C in an opposed direction for rotating the connecting shaft 201C in that corresponding direction, which is then adapted to displace upwardly along the driving compartment 17C for receiving the stationary units 14A back into the base housing 10A.

When all the stationary units 14A are received into the base housing 10A so that the transferring wheels 15A are positioned underneath the stationary units 14A, the outdoor umbrella is readily transported by the transferring wheels 15A (i.e. the transportation mode).

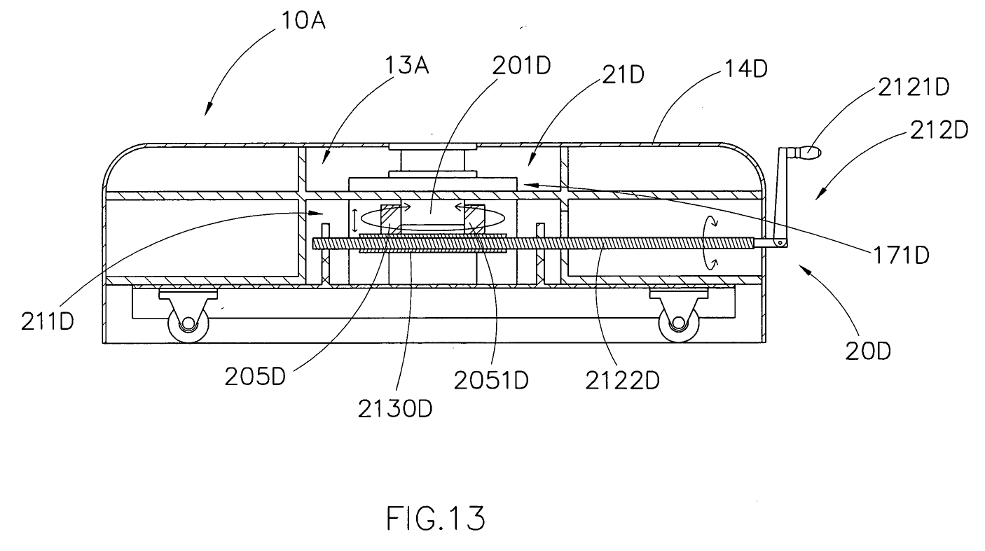

Referring to FIG. 13 of the drawings, a third alternative mode of the adjustable rotation base according to the above second preferred embodiment of the present invention is illustrated. The third alternative mode is similar to the second preferred embodiment except the transportation arrangement 20D, and that the stationary unit 14D is integrally incorporated with the base housing 10A to become a supporting frame for the base housing 10A.

According to the third alternative mode, the transportation arrangement 20D comprises a driving unit 21D operatively and spacedly provided in the base housing 10A, wherein the driving unit 21D is adapted to be selectively activated to operate the base housing 10A between the idle mode and the transportation mode.

The driving unit 21D comprises an adjustment assembly 211D mounted in the receiving cavity 13A and a manual actuation unit 212D extended from the adjustment assembly 211D out of the base housing 10A in such a manner that the manual actuation unit 212D is adapted to be manually and selectively operated for driving the adjustment assembly 211D to lift up the base housing 10A with respect to the ground surface.

The adjustment assembly 211D comprises a connecting shaft 201D connecting with the base housing 10A and longitudinally extending within the driving compartment 171A of the base housing 10A.

Moreover, the adjustment assembly 211D further comprises a plurality of rotary members 205D securely provided within the driving compartment 171A of the corresponding seat portion 17A of the base housing 10A to engage with the connecting shaft 201D. Each of the rotary members 205D has a circular, ring-shaped cross section, and a threaded inner surface for forming a plurality of screwing teeth on the inner surface of the respective rotary member 205D. On the other hand, the connecting shaft 201D further has a plurality of teeth 2051D formed thereon to engage with the threaded inner surface of the rotary member 205D, in such a manner that when the connecting shaft 201D is driven to rotate, the connecting shaft 201D also displaces longitudinally along the driving compartment 171A to initiate a linear movement stationary unit 14D.

On the other hand, each of the manual actuation unit 212D comprises a handle member 2121D extended out of the base housing 10A in a rotatably movable manner, an actuation rod 2122D extended from the connecting shaft 201D to the handling member 2121D, and an actuation rotor 2130D coupling with the actuation rod 2122D and the rotary members 205D in such a manner that when the actuation rod 2122D is driven to rotate about its own axis, the actuation rotor 2130D is arranged to be driven to rotate about the longitudinal axis of the connecting shaft 201D. Thus, when the handle member 2121D is driven to rotate in a predetermined direction, the actuation rod 2122D is also driven to rotate about its own axis which then drives the rotary members 205D to rotate about the longitudinal axis of the connecting shaft 201D. As such, the connecting shaft 201D, which is coupling with the rotary members 205D, is also driven to move upwardly and longitudinally to bias against the supporting frame as the stationary unit 14D. Therefore, the connecting shaft 201D is adapted to uplift the stationary unit 14D and eventually the entire base housing 10A with respective to the ground surface so as to allow the transferring wheels 15A to be positioned underneath the base housing 10A (i.e. transportation mode). At this transportation mode, a user is able to transport the outdoor umbrella 70A via the transferring wheels 15A.

Conversely, when the handle member 2121D is rotated at an opposed direction, the actuation rod 2122D is also driven to rotate about its own axis which then drives the rotary members 205D to rotate about the longitudinal axis of the connecting shaft 201D in the corresponding direction as opposed to lifting up the base housing 10A. As such, the connecting shaft 201D, which is coupling with the rotary members 205D, is also driven to move downwardly and longitudinally for releasing an upward urging force towards the supporting frame as the stationary unit 14D. Therefore, the entire base housing 10A and the stationary unit 14D is gradually lowered to sit on the ground surface (i.e. the idle mode) for securely supporting the outdoor umbrella 70A.

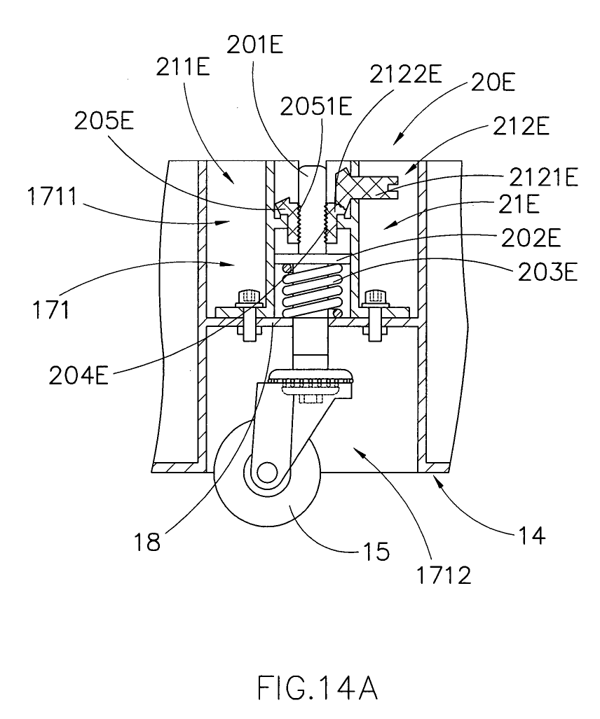

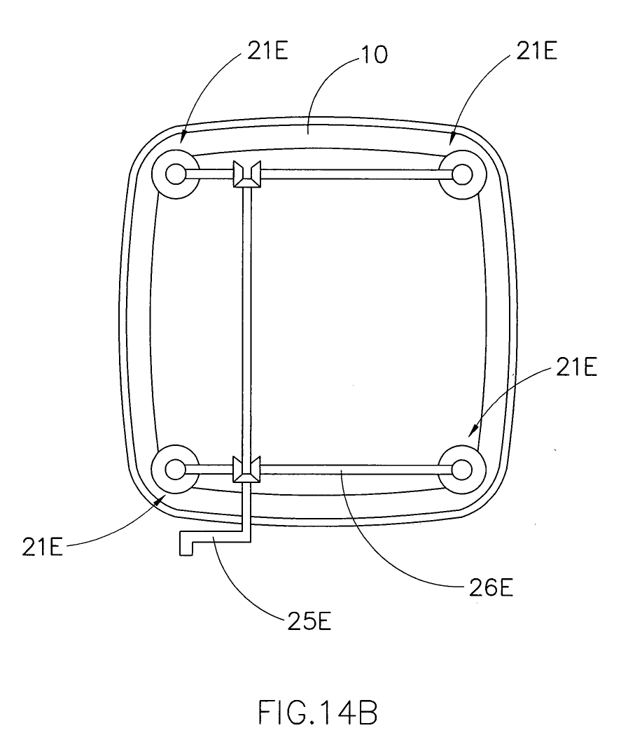

Referring to FIG. 14A and FIG. 14B of the drawings, a fourth alternative mode of the adjustable rotation base according to the preferred embodiment of the present invention is illustrated. The fourth alternative mode is similar to the preferred embodiment except the transportation arrangement 20E.

According to the fourth alternative mode, the transportation arrangement 20E comprises a plurality of driving units 21E operatively and spacedly provided in the base housing 10 to mechanically communicate with the stationary units 14 respectively, wherein the driving units 21E are adapted to be selectively activated to operate the base housing 10 between the idle mode and the transportation mode.

Each of the driving units 21E comprises an adjustment assembly 211E mounted in the receiving cavity 13 and a manual actuation unit 212E extended from the adjustment assembly 211E out of the base housing 10 in such a manner that the manual actuation unit 212E is adapted to be manually and selectively operated for driving the adjustment assembly 211E to lift up the base housing 10 with respect to the ground surface.

For each of the driving units 21E, the adjustment assembly 211E comprises a connecting shaft 201E, having a lower end portion directly connecting with the corresponding transferring wheels 15, longitudinally extended within the driving compartment 171 of the base housing 10.

According to the fourth alternative mode, the adjustment assembly 211E further comprises a rotary member 205E securely provided within the driving compartment 171 of the corresponding seat portion 17 of the base housing 10 to engage with the connecting shaft 201E. The rotary member 205E has a circular, ring-shaped cross section, wherein the rotary member 205E has a threaded inner surface for forming a plurality of screwing teeth 2051E on the inner surface of the rotary member 205E. On the other hand, the connecting shaft 201E further has a plurality of teeth 204E formed thereon to engage with the threaded inner surface of the rotary member 205E, in such a manner that when the connecting shaft 201E is driven to rotate, the connecting shaft 201E also displaces longitudinally along the driving compartment 171 to initiate a linear movement of the transferring wheels 15.

On the other hand, each of the manual actuation unit 212E comprises a handle member 2121E extended out of the base housing 10 in a rotatably movable manner, and an actuation member 2122E rotatably mounted on the base housing 10 to engage with the rotary member 205E of the adjustment assembly 211E. When the handle member 2121E is drive to rotate, the actuation member 2122E is also driven to rotate so as to drive the connecting shaft 201E to displace linearly along the driving compartment 171 for lowering the corresponding transferring wheel 15. The resilient element 203E is disposed between the base panel 18 and the biasing member 202E to normally exert an upward urging force toward the connecting shaft 201E so as to normally retain the corresponding transferring wheel 15 within the lower compartment chamber 1712.

The transportation arrangement 20E further comprises a main actuation handle 25E movably extended from the base housing 10 and a plurality of actuating members 26E operatively connected between the main actuation handle 25E and the four driving units 21E in such a manner that when the main actuation handle 25E is driven to rotate, the actuating members 26E are also driven to operate the driving units 21E in the above-mentioned manner so as to operate the main housing 10 idle mode and the transportation mode by one single main actuating handle 25E.

When all of the transferring wheels 15 are descended to a position underneath the base housing 10, the outdoor umbrella is movably supported by the transferring wheels 15. When the user wishes to restore the position of the transferring wheels 15, he or she simply needs to rotate the handle member 2121E in an opposed direction for rotating the connecting shaft 201E in that corresponding direction, which is then adapted to displace upwardly along the driving compartment 17 for receiving the transferring wheels 15 back into the base housing 10. The stationary units 14E in this fourth alternative mode are embodied as the bottom surfaces of the base housing 10.

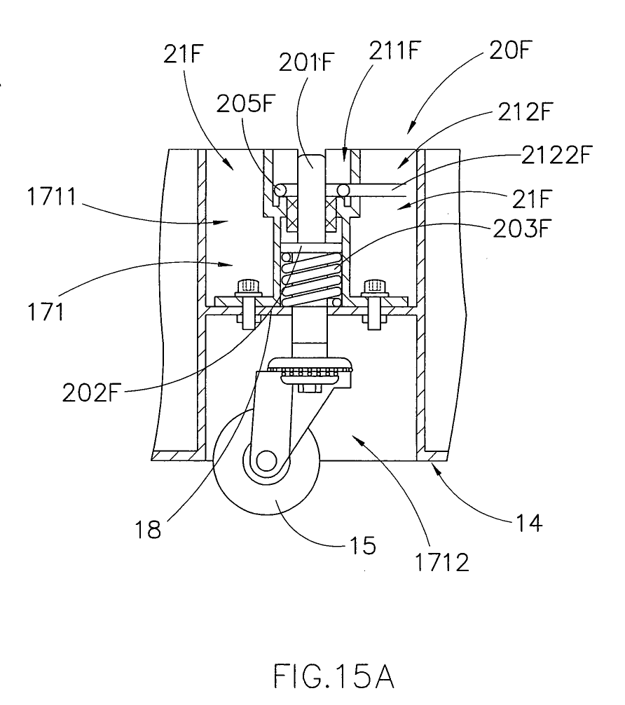

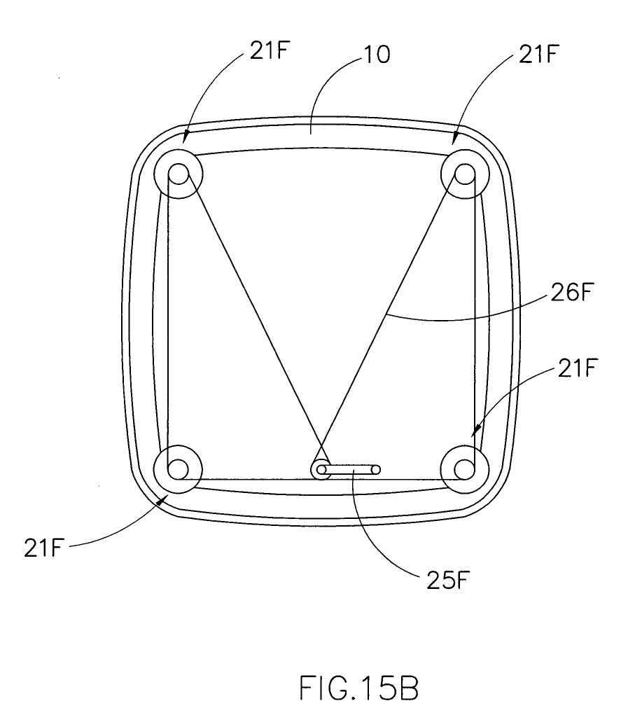

Referring to FIG. 15A and FIG. 15B of the drawings, a fifth alternative mode of the adjustable rotation base according to the preferred embodiment of the present invention is illustrated. The fifth alternative mode is similar to the preferred embodiment except the transportation arrangement 20F.

The transportation arrangement 20F comprises a plurality of driving units 21F operatively and spacedly provided in the base housing 10 to mechanically communicate with the stationary units 14 respectively, wherein the driving units 21F are adapted to be selectively activated to operate the base housing 10 between the idle mode and the transportation mode.

Each of the driving units 21F comprises an adjustment assembly 211F mounted in the receiving cavity 13 and a manual actuation unit 212F extended from the adjustment assembly 211F out of the base housing 10 in such a manner that the manual actuation unit 212F is adapted to be manually and selectively operated for driving the adjustment assembly 211F to lift up the base housing 10 with respect to the ground surface.

For each of the driving units 21F, the adjustment assembly 211F comprises a connecting shaft 201F, having a lower end portion directly connecting with the corresponding transferring wheels 15, longitudinally extended within the driving compartment 171 of the base housing 10.

According to the fifth alternative mode, the adjustment assembly 211F further comprises a rotary member 205F securely provided within the driving compartment 171 of the corresponding seat portion 17 of the base housing 10 to engage with the connecting shaft 201F. On the other hand, each of the manual actuation units 212F comprises an actuation member 2122F, preferably embodied as a driving chain, movably mounted on the base housing 10 to engage with the rotary member 205F of the adjustment assembly 211F. When the actuation member 2122F is driven to move, the connecting shaft 201F is also driven to displace linearly along the driving compartment 171 for lowering the corresponding transferring wheel 15. The resilient element 203F is disposed between the base panel 18 and the biasing member 202F to normally exert an upward urging force toward the connecting shaft 201F so as to normally retain the corresponding transferring wheel 15 within the lower compartment chamber 1712.

The transportation arrangement 20F further comprises a main actuation handle 25F movably extended from the base housing 10 and a plurality of actuating chains 26F operatively connected between the main actuation handle 25F and the four driving units 21F in such a manner that when the main actuation handle 25F is driven to rotate, the actuating chains 26F are also driven to operate the driving units 21F in the above-mentioned manner so as to operate the main housing 10 idle mode and the transportation mode by one single main actuating handle 25F.

When all of the transferring wheels 15 are descended to a position underneath the base housing 10, the outdoor umbrella is movably supported by the transferring wheels 15. When the user wishes to restore the position of the transferring wheels 15, he or she simply needs to rotate the main handle member 25F in an opposed direction for rotating the connecting shaft 201F in that corresponding direction, which is then adapted to displace upwardly along the driving compartment 17 for receiving the transferring wheels 15 back into the base housing 10. The stationary units 14 in this fifth alternative mode are embodied as the bottom surfaces of the base housing 10.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

1-2. (canceled)

3. An adjustable rotation base for supporting an outdoor umbrella having a supporting post on a ground surface, wherein said adjustable rotation base comprises:
a base housing having a bottom side, an upper side for coupling with said supporting post to support said outer umbrella in an upright manner, and a receiving cavity indently formed on said bottom side of said base housing, wherein said base housing comprises a stationary unit provided at said bottom side for stationary sitting on the ground surface and a plurality of transferring wheels rotatably supported at said bottom side of said base housing; and
an transportation arrangement provided at said base housing to operate said base housing between an idle mode and a transportation mode, wherein in said idle mode, said transferring wheels are suspenedly lifted up to define a clearance between said transferring wheels and the ground surface such said base housing is stationary sat on the ground surface via said stationary unit, and in said transportation mode, said stationary unit is upwardly lifted to allow said transferring wheels being sitting on the ground surface, such that said base housing is adapted to be transported on the ground surface via said transferring wheels,
wherein said transportation arrangement comprises a plurality of driving units each of which comprises an adjustment assembly mounted in said receiving cavity and a manual actuation unit extended from said adjustment assembly out of said base housing in such a manner that said manual actuation unit is adapted to be manually and selectively operated for driving said adjustment assembly to lift up and lower down said transferring wheels with respect to said base housing,
wherein said base housing further comprises a partitioning wall, and has a plurality of seat portions formed as four corner portions of said base housing, wherein said transferring wheels and said driving units are coupled at said corresponding seat portions for selectively operating said base housing between said idle mode and said transportation mode, each of said seat portions being divided into a driving compartment and a control compartment by said partitioning wall, wherein said adjustment assembly and said manual actuation unit are mounted in said driving compartment and said control compartment respectively and communicate with each other through said communication slot of said partitioning wall.

4. The adjustable rotation base, as recited in claim 3, wherein said base housing further comprises a base panel transversely extended between an inner side of said partitioning wall and an inner side of said opposed sidewall of said driving compartment so as to further divide said driving compartment into an upper compartment chamber for receiving said adjustment assembly, and a lower compartment chamber for receiving said transferring wheels.

5. The adjustable rotation base, as recited in claim 4, wherein for each of said driving units, said adjustment assembly comprises a connecting shaft, having a lower end portion connected with said corresponding transferring wheel, longitudinally extended within said driving compartment of said base housing, a biasing member outwardly extended from said connecting shaft within said upper compartment chamber at a position which is spacedly apart from an upper surface of said base panel, and a resilient element disposed between said base panel and said biasing member to normally exert an upward urging force toward said connecting shaft so as to normally retain said corresponding transferring wheel within said lower compartment chamber.

6. The adjustable rotation base, as recited in claim 5, wherein each of said adjustment assemblies further comprises a plurality of locking teeth formed an outer side of said connecting shaft for engaging with said corresponding manual actuation unit, wherein each of said manual actuation units comprises an actuation pedal, having a driving end portion and an actuation end portion, extended from said adjustment assembly to said control compartment, a first and a second locking members pivotally and downwardly extended from said actuation end portion of said actuation pedal for selectively engaging with said locking teeth so as to selectively retain said corresponding transferring wheel for said idle mode and said transportation mode.

7. The adjustable rotation base, as recited in claim 6, wherein said manual actuation unit further comprises a plurality of retention springs mounted within said upper compartment chamber of said driving compartment to normally bias against said locking members respectively so as to ensure said locking members normally engaging with said locking teeth for restricting a lateral movement between said connecting shaft and said actuation pedal.

8. The adjustable rotation base, as recited in claim 7, wherein each of said manual actuation units further comprises a resilient member mounted in said control compartment of said corresponding seat portion of said base housing to normally exert an upward urging force toward said actuation end portion of said actuation pedal, which is adapted for being stepped on by a user to actuate said corresponding adjustment assembly.

9. The adjustable rotation base, as recited in claim 4, wherein for each of said driving units, said adjustment assembly comprises a connecting shaft, having a lower end portion communicating with said corresponding transferring wheel, longitudinally extended within said driving compartment of said base housing, a biasing member outwardly extended from said connecting shaft within said upper compartment chamber at a position which is spacedly apart from an upper surface of said base panel, a resilient element disposed between said base panel and said biasing member to normally exert an upward urging force toward said connecting shaft so as to normally retain said corresponding transferring wheel within said lower compartment chamber.

10. The adjustable rotation base, as recited in claim 9, each of said adjustment assemblies further comprises a rotary member movably provided within said driving compartment to engage with said lower end portion of said connecting shaft, wherein said rotary member has a circular, ring-shaped cross section, and a threaded inner surface for forming a plurality of screwing teeth thereon, wherein said connecting shaft further has a plurality of teeth formed thereon to engage with said threaded inner surface of said rotary member, in such a manner that when said connecting shaft is driven to rotate, said rotary member is also driven to rotate so as to initiate a linear movement within said driving compartment of said base housing for selectively uplifting and lowering said corresponding transferring wheel.

11. The adjustable rotation base, as recited in claim 9, wherein each of said manual activation units comprises a handle member extended out of said base housing in a rotatably movable manner, and an actuation rod extended from an upper end portion of said connecting shaft to said handling member, in such a manner that when said handle member is driven to rotate in a predetermined direction, said connecting shaft is also driven to rotate for lowering said corresponding transferring wheel to allow said transportation arrangement to be in said transportation mode, and when said handle member is driven to rotate in an opposed direction when said transportation arrangement is in said transportation mode, said rotary member is also driven to rotate to displace upwardly along said connecting shaft for receiving into said base housing and restore said transportation arrangement at said idle mode.

12. The adjustable rotation base, as recited in claim 4, wherein for each of said driving units, said adjustment assembly comprises a connecting shaft, having a lower end portion directly connecting with said corresponding transferring wheel, longitudinally extended within said driving compartment of said base housing, and a rotary member securely provided within said driving compartment to engage with said lower end portion of said connecting shaft, wherein said rotary member has a circular, ring-shaped cross section, and a threaded inner surface for forming a plurality of screwing teeth thereon, wherein said connecting shaft further has a plurality of teeth formed thereon to engage with said threaded inner surface of said rotary member, in such a manner that when said connecting shaft is driven to rotate, said connecting shaft also displaces longitudinally along said driving compartment to initiate a linear movement of said transferring wheel.

13. The adjustable rotation base, as recited in claim 12, wherein each of said manual activation units comprises a handle member extended out of said base housing in a rotatably movable manner, and an actuation rod extended from an upper end portion of said connecting shaft to said handling member, in such a manner that when said handle member is driven to rotate in a predetermined direction, said connecting shaft is also driven to rotate for lowering said corresponding transferring wheel to allow said transportation arrangement to be in said transportation mode, and when said handle member is driven to rotate in an opposed direction when said transportation arrangement is in said transportation mode, said connecting shaft is also driven to rotate to displace upwardly so as to receive said corresponding transferring wheel into said base housing and restore said transportation arrangement at said idle mode.

14. (canceled)

15. An adjustable rotation base for supporting an outdoor umbrella having a supporting post on a ground surface, wherein said adjustable rotation base comprises:
a base housing having a bottom side, an upper side for coupling with said supporting post to support said outer umbrella in an upright manner, and a receiving cavity indently formed on said bottom side of said base housing, wherein said base housing comprises a stationary unit provided at said bottom side for stationary sitting on the ground surface and a plurality of transferring wheels rotatably supported at said bottom side of said base housing: and
an transportation arrangement provided at said base housing to operate said base housing between an idle mode and a transportation mode, wherein in said idle mode, said transferring wheels are suspenedly lifted up to define a clearance between said transferring wheels and the ground surface such said base housing is stationary sat on the ground surface via said stationary unit, and in said transportation mode, said stationary unit is upwardly lifted to allow said transferring wheels being sitting on the ground surface, such that said base housing is adapted to be transported on the ground surface via said transferring wheels,
wherein said transportation arrangement comprises a plurality of driving units operatively and spacedly provided in said base housing to mechanically communicate with said stationary units respectively, wherein said driving units are adapted to be selectively activated to operate said base housing between said idle mode and said transportation mode, wherein each of said stationary units comprises a supporting member movably extended from a bottom portion of said base housing.
wherein said base housing further comprises a partitioning wall, and has a plurality of seat portions formed as four corner portions of said base housing, wherein said stationary units and said driving units are coupled at said corresponding seat portions for selectively operating said base housing between said idle mode and said transportation mode, each of said seat portions being divided into a driving compartment and a control compartment by said partitioning wall, wherein said adjustment assembly and said manual actuation unit are mounted in said driving compartment and said control compartment respectively and communicate with each other through said communication slot of said partitioning wall.

16. The adjustable rotation base, as recited in claim 15, wherein said base housing further comprises a base panel transversely extended between an inner side of said partitioning wall and an inner side of said opposed sidewall of said driving compartment so as to further divide said driving compartment into an upper compartment chamber for receiving said adjustment assembly, and a lower compartment chamber for receiving said stationary unit.

17. The adjustable rotation base, as recited in claim 16, wherein for each of said driving units, said adjustment assembly comprises a connecting shaft, having a lower end portion connected with said corresponding stationary unit, longitudinally extended within said driving compartment of said base housing, a biasing member outwardly extended from said connecting shaft within said upper compartment chamber at a position which is spacedly apart from an upper surface of said base panel, and a resilient element disposed between said base panel and said biasing member to normally exert an upward urging force toward said connecting shaft so as to normally retain said corresponding stationary unit within said lower compartment chamber for retaining transportation arrangement in said transportation mode.

18. The adjustable rotation base, as recited in claim 17, wherein each of said adjustment assemblies further comprises a plurality of locking teeth formed an outer side of said connecting shaft for engaging with said corresponding manual actuation unit, wherein each of said manual actuation units comprises an actuation pedal, having a driving end portion and an actuation end portion, extended from said adjustment assembly to said control compartment, a first and a second locking members pivotally and downwardly extended from said actuation end portion of said actuation pedal for selectively engaging with said locking teeth so as to selectively retain said corresponding stationary unit for said idle mode and said transportation mode.

19. The adjustable rotation base, as recited in claim 18, wherein said manual actuation unit further comprises a plurality of retention springs mounted within said upper compartment chamber of said driving compartment to normally bias against said locking members respectively so as to ensure said locking members normally engaging with said locking teeth for restricting a lateral movement between said connecting shaft and said actuation pedal.

20. The adjustable rotation base, as recited in claim 19, wherein each of said manual actuation units further comprises a resilient member mounted in said control compartment of said corresponding seat portion of said base housing to normally exert an upward urging force toward said actuation end portion of said actuation pedal, which is adapted for being stepped on by a user to actuate said corresponding adjustment assembly.

21. The adjustable rotation base, as recited in claim 16, wherein for each of said driving units, said adjustment assembly comprises a connecting shaft, having a lower end portion communicating with said corresponding stationary unit, longitudinally extended within said driving compartment of said base housing, a biasing member outwardly extended from said connecting shaft within said upper compartment chamber at a position which is spacedly apart from an upper surface of said base panel, a resilient element disposed between said base panel and said biasing member to normally exert an upward urging force toward said connecting shaft so as to normally retain said corresponding stationary unit within said lower compartment chamber.

22. The adjustable rotation base, as recited in claim 21, each of said adjustment assemblies further comprises a rotary member movably provided within said driving compartment to engage with said lower end portion of said connecting shaft, wherein said rotary member has a circular, ring-shaped cross section, and a threaded inner surface for forming a plurality of screwing teeth thereon, wherein said connecting shaft further has a plurality of teeth formed thereon to engage with said threaded inner surface of said rotary member, in such a manner that when said connecting shaft is driven to rotate, said rotary member is also driven to rotate so as to initiate a linear movement within said driving compartment of said base housing for selectively uplifting and lowering said corresponding stationary unit.

23. The adjustable rotation base, as recited in claim 22, wherein each of said manual activation units comprises a handle member extended out of said base housing in a rotatably movable manner, and an actuation rod extended from an upper end portion of said connecting shaft to said handling member, in such a manner that when said handle member is driven to rotate in a predetermined direction, said connecting shaft is also driven to rotate for lowering said corresponding stationary unit to allow said transportation arrangement to be in said idle mode, and when said handle member is driven to rotate in an opposed direction when said transportation arrangement is in said idle mode, said rotary member is also driven to rotate to displace upwardly along said connecting shaft for receiving into said base housing and restore said transportation arrangement at said transportation mode.

24. The adjustable rotation base, as recited in claim 16, wherein for each of said driving units, said adjustment assembly comprises a connecting shaft, having a lower end portion directly connecting with said corresponding stationary unit, longitudinally extended within said driving compartment of said base housing, and a rotary member securely provided within said driving compartment to engage with said lower end portion of said connecting shaft, wherein said rotary member has a circular, ring-shaped cross section, and a threaded inner surface for forming a plurality of screwing teeth thereon, wherein said connecting shaft further has a plurality of teeth formed thereon to engage with said threaded inner surface of said rotary member, in such a manner that when said connecting shaft is driven to rotate, said connecting shaft also displaces longitudinally along said driving compartment to initiate a linear movement of said stationary unit.

25. The adjustable rotation base, as recited in claim 12, wherein each of said manual activation units comprises a handle member extended out of said base housing in a rotatably movable manner, and an actuation rod extended from an upper end portion of said connecting shaft to said handling member, in such a manner that when said handle member is driven to rotate in a predetermined direction, said connecting shaft is also driven to rotate for lowering said corresponding stationary unit to allow said transportation arrangement to be in said idle mode, and when said handle member is driven to rotate in an opposed direction when said transportation arrangement is in said idle mode, said connecting shaft is also driven to rotate to displace upwardly so as to receive said corresponding stationary unit into said base housing and drive said transportation arrangement to be at said transportation mode.

26-28. (canceled)

29. An adjustable rotation base for supporting an outdoor umbrella having a supporting post on a ground surface, wherein said adjustable rotation base comprises:
a base housing having a bottom side, an upper side for coupling with said supporting post to support said outer umbrella in an upright manner, and a receiving cavity indently formed on said bottom side of said base housing, wherein said base housing comprises a stationary unit provided at said bottom side for stationary sitting on the ground surface and a plurality of transferring wheels rotatably supported at said bottom side of said base housing; and
an transportation arrangement provided at said base housing to operate said base housing between an idle mode and a transportation mode, wherein in said idle mode, said transferring wheels are suspenedly lifted up to define a clearance between said transferring wheels and the ground surface such said base housing is stationary sat on the ground surface via said stationary unit, and in said transportation mode, said stationary unit is upwardly lifted to allow said transferring wheels being sitting on the ground surface, such that said base housing is adapted to be transported on the ground surface via said transferring wheels,
wherein said stationary units are integrally connected with each other and extend to form a supporting frame provided within said base housing in such a manner that said stationary unit is adapted to be selectively lifted up for allowing said transportation mode to be in said transportation mode and said idle mode,
wherein said transportation arrangement comprises a plurality of driving units each of which comprises an adjustment assembly mounted in said receiving cavity and a manual actuation unit extended from said adjustment assembly out of said base housing in such a manner that said manual actuation unit is adapted to be manually and selectively operated for driving said adjustment assembly to lift up and lower down said stationary units with respect to said base housing so as to selectively drive said transportation arrangement to said transportation mode and said idle mode respectively,
wherein each of said adjustment assemblies comprises a connecting shaft communicating with said base housing and longitudinally extending within said driving compartment of said base housing, and a plurality of rotary members securely provided within said driving compartment to engage with said connecting shaft, wherein each of said rotary members has a circular, ring-shaped cross section, and a threaded inner surface for forming a plurality of screwing teeth thereon, wherein said connecting shaft further has a plurality of teeth formed thereon to engage with said threaded inner surface of said rotary member, in such a manner that when said rotary members are driven to rotate, said connecting shaft displaces longitudinally along said driving compartment to initiate a linear movement of said stationary unit,
wherein each of said manual actuation units comprises a handle member extended out of said base housing in a rotatably movable manner, an actuation rod extended from said connecting shaft to said handling member, and an actuation rotor coupling with said actuation rod and said rotary members in such a manner that when said actuation rod is driven to rotate about a principal axis, said actuation rotor is arranged to be driven to rotate about said longitudinal axis of said connecting shaft, in such a manner that when said handle member is driven to rotate in a predetermined direction, said actuation rod is also driven to rotate about said principal axis which then drives said rotary members to rotate about said longitudinal axis of said connecting shaft for switching said transportation arrangement to said transportation mode, and when said handle member is rotated at an opposed direction, said actuation rod is also driven to rotate correspondingly to drive said rotary members to rotate in a corresponding direction to lower said connecting shaft with respect to said base housing, which then release an upward urging force towards the supporting frame as said stationary unit for restoring said transportation arrangement to said idle mode.

30. The adjustable rotation base, as recited in claim 4, wherein said each of said adjustment assemblies comprises a connecting shaft, having a lower end portion directly connecting with said corresponding transferring wheels, longitudinally extended within said driving compartment of said base housing, and a rotary member securely provided within said driving compartment to engage with said connecting shaft, in such a manner that when said connecting shaft is driven to rotate, said connecting shaft is adapted to displace longitudinally along said driving compartment to initiate a linear movement of said respective transferring wheel.

31. The adjustable rotation base, as recited in claim 30, wherein said transportation arrangement further comprises a main actuation handle movably extended from said base housing, and a plurality of actuating members operatively connected between said main actuation handle and said driving units in such a manner that when said main actuation handle is driven to rotate, said actuating members are also driven to operate said driving units for operating said main housing between said idle mode and said transportation mode by said main actuating handle.

32. The adjustable rotation base, as recited in claim 4, wherein each of said adjustment assemblies comprises a connecting shaft, having a lower end portion directly connecting with said corresponding transferring wheels, longitudinally extended within said driving compartment of said base housing, and a rotary member securely provided within said driving compartment to engage with said connecting shaft, wherein each of said manual actuation units comprises an actuation member, which is embodied as a driving chain, movably mounted on said base housing to engage with said rotary member, such that when said actuation member is driven to move, said connecting shaft is also driven to displace linearly along said driving compartment for lowering said corresponding transferring wheel.

33. The adjustable rotation base, as recited in claim 32, wherein said transportation arrangement further comprises a main actuation handle movably extended from said base housing, and a plurality of actuating chains operatively connected between said main actuation handle and said four driving units in such a manner that when said main actuation handle is driven to rotate, said actuating chains are also driven to operate said driving units for operating said main housing between said idle mode and said transportation mode.
